(19) United States
(12) Patent Application Publication
(10) Pub. No.: US 2014/0184054 A1
(43) Pub. Date: Jul. 3, 2014

(54) Clad Electrode for Spark Plug and Method For Manufacturing Same

(71) Applicants: Yukimasa Nomura, Hiratsuka-shi (JP); Masamitsu Imai, Hiratsuka-shi (JP); Kunihiro Tanaka, Hiratsuka-shi (JP)

(72) Inventors: Yukimasa Nomura, Hiratsuka-shi (JP); Masamitsu Imai, Hiratsuka-shi (JP); Kunihiro Tanaka, Hiratsuka-shi (JP)

(73) Assignee: TANAKA KIKINZOKU KOGYO K.K., TOKYO (JP)

(21) Appl. No.: 14/163,702

(22) PCT Filed: Jul. 24, 2012
(86) PCT No.: PCT/JP2012/068656

§ 371 Date: Mar. 4, 2014

(30) Foreign Application Priority Data
Jul. 28, 2011 (JP) 2011-164890

(51) Int. Cl. H01T 13/39; H01T 21/02

(52) U.S. Cl. CPC H01T 13/39; H01T 21/02
USPC 313/141; 445/7

(57) ABSTRACT

A clad electrode for a spark plug used as an center electrode and a ground electrode of a spark plug composed of a precious metal tip arranged at the leading end of a spark plug and a base material to which the precious metal tip is joined, wherein a junction interface between the precious metal tip and the base material is substantially planar, and a 5 μm to 100 μm-thick diffusion layer is formed in the joined part of the clad electrode. This clad electrode is manufactured with placing the joining face of a substantially columnar precious metal tip in abutting contact with a surface of the base material, preliminarily joining the precious metal tip to the surface of the base material with resistance welding, punching out a part in which the base material and the precious metal tip are integrated with each other, and diffusion-joining the base material and the precious metal tip with heat treatment.

### BACKGROUND OF THE INVENTION

1. Field of the Invention

The present invention relates to electrodes (center electrode and ground electrode) of a spark plug, and particularly, to a clad electrode for a spark plug formed with joining a precious metal tip and a base material and a method for manufacturing the clad electrode.

2. Description of the Related Art

As a center electrode of a spark plug used in an internal-combustion engine or the like, a so-called clad electrode has been known recently in which a precious metal tip made of a Pt alloy or an Ir alloy is joined to a base material, such as a Ni alloy or a Cu alloy.

In such a clad electrode for a spark plug, the precious metal tip and the base material are dissimilar materials. Accordingly, resistance welding or laser welding is used to join the materials and ensure junction stability (see, for example, Patent Literature 1).

Incidentally, laser welding is often used when a precious metal tip is joined to a base material, such as a Ni alloy, since resistance welding alone cannot ensure junction strength. In this laser welding, laser light is radiated onto the outer peripheral surface of a part of contact between the precious metal tip and the base material to melt the irradiated location, thereby joining the precious metal tip and the base material.

Since this laser welding is a method for joining the precious metal tip and the base material with melting the junction therebetween from the outer peripheral surface of the junction, however, the junction may go into an unmelted state inside a joining face. Consequently, voids may remain in a junction interface. In this case, the expansion of a gas trapped inside a void may cause cracks when the spark plug is exposed to high temperature while in use. The precious metal tip is thus liable to separate from the base material. In particular, the use environment of the spark plug is high in temperature in a recent internal-combustion engine. Accordingly, the spark plug often has the problem of, for example, the precious metal tip dropping off due to the effect of excessive cooling-heating cycles of heat generation and release caused with the repetition of discharge and ignition. It is thus pointed out that the service life of the spark plug is exhausted in a shortened period of time.

In addition, if the amount of laser heating is increased in an attempt to also completely melt the inner side of the joining face to form a junction, the width of a molten zone on the outer peripheral surface of the junction increases. This molten zone is a region formed with the meltage and solidification of materials, differs in material texture from other locations, and is brittle and inferior in electrical properties. The material of the molten zone is therefore not effective as a plug material. An increase in the width of the molten zone thus requires the length (thickness) of the precious metal tip to be increased as much. Accordingly, the method is not preferred from the viewpoint of cost or natural resources saving.

### PRIOR ART DOCUMENTS

### Patent Literature

Patent Literature 1: Japanese Patent Application Laid-Open No. 2004-134209

### SUMMARY OF THE INVENTION

### Problems To Be Solved By the Invention

The present invention has been accomplished in view of the above-described circumstances. Accordingly, an object of the present invention is to provide a technique to manufacture a clad electrode formed of a precious metal tip and a base material, the technique being capable of securely maintaining junction between the precious metal tip and the base material and extending the service life of a spark plug, wherein a precious metal tip having a minimum necessary length is used in the clad electrode.

### Means For Solving the Problems

The present invention is a clad electrode for a spark plug used as an electrode of a spark plug composed of a precious metal tip arranged at the leading end of the spark plug and a base material to which the precious metal tip is joined, wherein a junction interface between the precious metal tip and the base material is substantially planar.

In a clad electrode for a spark plug of the present invention, a joining process including a serial process of resistance welding and diffusion joining is adopted for junction between a precious metal tip and a base material, in substitution for conventional laser welding. In diffusion joining, a diffusion layer is formed over the entire range of a junction interface to securely join the precious metal tip and the base material, thereby preventing the separation and dropping off of the precious metal tip. Accordingly, it is possible to extend the service life of a spark plug even in a harsh use environment. In addition, this diffusion layer is small in thickness variation, smooth and uniform, and the junction interface is substantially planar. The thickness of the diffusion layer can be controlled with welding conditions. It is thus possible to set the length of the precious metal tip to a minimum.

The thickness of the diffusion layer is preferably 5 μm to 100 μm. If this thickness is less than 5 μm, sufficient junction strength is unlikely to be available. If this thickness exceeds 100 μm, a Ni-based alloy or a Cu-based alloy vulnerable to spark wear (discharge wear) is likely to be present on (in the vicinity of) a discharge face at a high concentration. The service life of the spark plug is thus liable to shorten. Note that this diffusion layer is formed as the result of Ni or Cu diffusing toward the precious metal tip side in a case where a Ni alloy or a Cu alloy, for example, is used as the base material.

The clad electrode for a spark plug according to the present invention may include an unjoined part on the outer peripheral surface of a joined part. Even if the unjoined part is present on the outer peripheral surface, a strong junction is formed inside the joined part. The precious metal tip therefore does not separate from the base material. In addition, this unjoined part can serve as a buffer part for relieving a heat cycle-induced expansion/contraction difference caused between the precious metal tip and the base material in the joined part. Note that the length (mean value) of this unjoined part is allowed to be at most one-fifth of the radius of the precious metal tip.

The precious metal tip in the present invention is preferably a Pt alloy or an Ir alloy. Specifically, examples of the precious metal tip include a Pt—Rh alloy, a Pt—Ir alloy, a Pt—Ni alloy, a Pt—Cu alloy, an Ir—Rh alloy, an Ir—Pt alloy, and an Ir—Fe Ni Cr alloy. In addition, the base material in the present invention is preferably a Ni alloy or a Cu alloy. Specifically, examples of the base material include a Ni—Cr alloy, a Ni—Fe—Al alloy, a Ni—Fe—Co alloy, a Ni—Pt alloy, a Ni—Pd alloy, a Ni—Ir alloy, a Cu—Cr alloy, a Cu—Ni alloy, a Cu—W alloy, a Cu—Pt alloy, a Cu—Ir alloy, and a Cu—Pd alloy. Yet additionally, the base material may be a gradient alloy material composed with combining the abovementioned types of base material in a layer-like manner.

The present invention also relates to a clad electrode material in which the joining face of a substantially columnar precious metal tip is placed in abutting contact with a surface of a base material, the precious metal tip is preliminarily joined to the surface of the base material with resistance welding, and the base material and the precious metal tip are diffusion-joined with heat treatment, thereby integrating the base material and the precious metal tip with each other.

A clad electrode for a spark plug according to the present invention can be manufactured with placing the joining face of a substantially columnar precious metal tip in abutting contact with a surface of a base material, preliminarily joining the precious metal tip to the surface of the base material with resistance welding, and diffusion-joining the base material and the precious metal tip with heat treatment. Since an increased amount of precious metal tip is melted in a conventional laser welding method, the amount of precious metal used tends to be large. According to the manufacturing method of the present invention, however, the clad electrode can be formed with only a necessary amount of precious metal. In addition, the clad electrode for a spark plug of the present invention can be formed through performing a preliminary joining process with a base material and a separately prepared precious metal tip, punching out a part in which the base material and the precious metal tip are integrated with each other, and then performing a thermal diffusion joining process. Consequently, it is possible to efficiently use various materials and reduce costs.

In the manufacturing method according to the present invention, resistance welding conditions in preliminary joining are preferably set to a welding force of 5 to 10 kgf, a welding current of 500 to 1500 A, and an electrical conduction time of 2 to 200 msec. Unlike common resistance welding, these preliminary joining conditions feature a high pressure, a low electrical current and a long electrical conduction time. Also in the manufacturing method according to the present invention, a heat treatment in diffusion joining is preferably performed either in vacuum, in a reduction atmosphere, or in an inert atmosphere under the conditions of 800 to 1200° C. and 1 to 5 hours. In particular, the heat treatment atmosphere is desirably free from the high-temperature oxidation of a Ni-based alloy and a Cu-based alloy.

In the manufacturing method according to the present invention, a required area of contact between the base material and the precious metal tip cannot be obtained if the welding force of preliminary joining is weak. Consequently, a gap is liable to arise in a joining face. If the welding force is strong, the precious metal tip may crush. This problem tends to cause a failure to obtain edges for improving ignition performance required of a spark plug. If the welding current of preliminary joining is too high, a void may arise in the vicinity of the joining face. Consequently, the phenomenon of the precious metal tip dropping off due to the decrease of junction strength is more likely to occur in an actual use environment. Surface dust is therefore liable to arise, thus possibly serving as a trigger for abnormal electrical discharge. In addition, an extended period of the electrical conduction time facilitates the diffusion of the junction interface but degrades production efficiency. This problem tends to cause a failure to materialize products at low cost. A shortened period of the electrical conduction time of preliminary joining may prevent the progress of thermal diffusion of atoms in the junction interface. This problem tends to cause difficulty in obtaining an adequate diffusion layer also in the diffusion treatment of the next step.

### Advantageous Effects of the Invention

According to the present invention, it is possible to securely maintain junction between a precious metal tip and a base material and extend the service life of a spark plug. In addition, according to a method for manufacturing a clad electrode of the present invention, it is possible to efficiently use materials and thereby reduce manufacturing costs.

### BRIEF DESCRIPTION OF THE DRAWINGS

FIG. 1A is a schematic cross-sectional view illustrating a process for manufacturing a clad electrode of the present embodiment.

FIG. 1B is a schematic cross-sectional view illustrating a process for manufacturing a clad electrode of the present embodiment.

FIG. 1C is a schematic cross-sectional view illustrating a process for manufacturing a clad electrode of the present embodiment.

FIG. 1D is a schematic cross-sectional view illustrating a process for manufacturing a clad electrode of the present embodiment.

FIG. 2 is a perspective view of a clad electrode of the present embodiment.

FIG. 3A is a cross-sectional observation photograph of a clad electrode (with an unjoined part) of the present embodiment.

FIG. 3B is a cross-sectional observation photograph of a clad electrode (without an unjoined part) of the present embodiment.

FIG. 4 is a cross-sectional observation photograph of a clad electrode formed with conventional laser welding.

FIG. 5 is a cross-sectional observation photograph of a clad electrode of the present embodiment after a heat cycle test.

### DETAILED DESCRIPTION OF THE PREFERRED EMBODIMENTS

Hereinafter, embodiments of the present invention will be described in detail, while referring to the accompanying drawings.

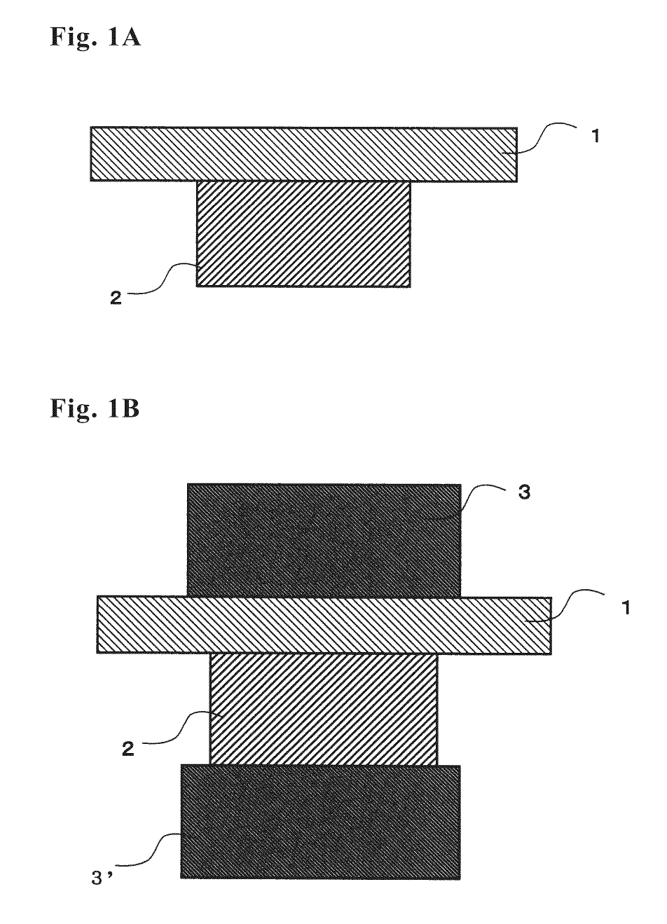

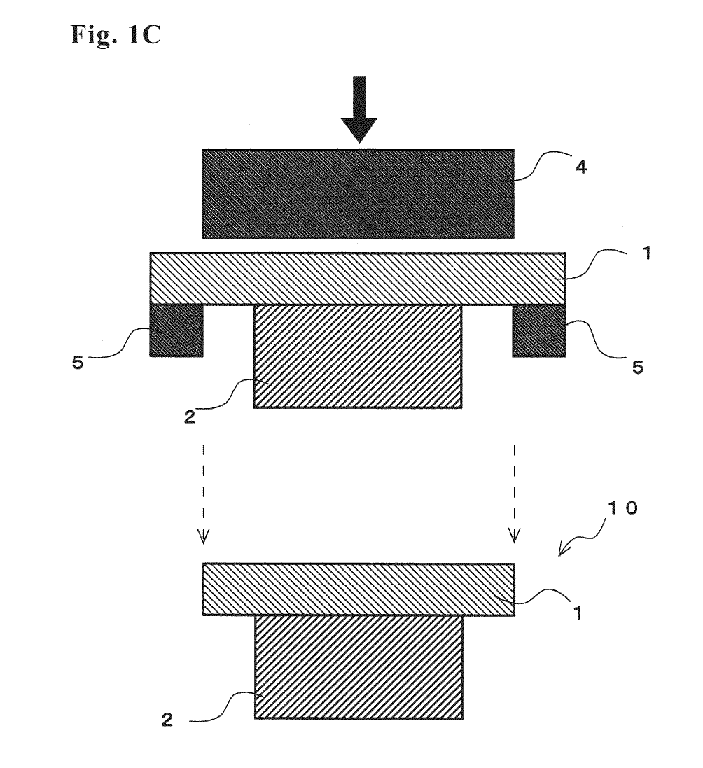

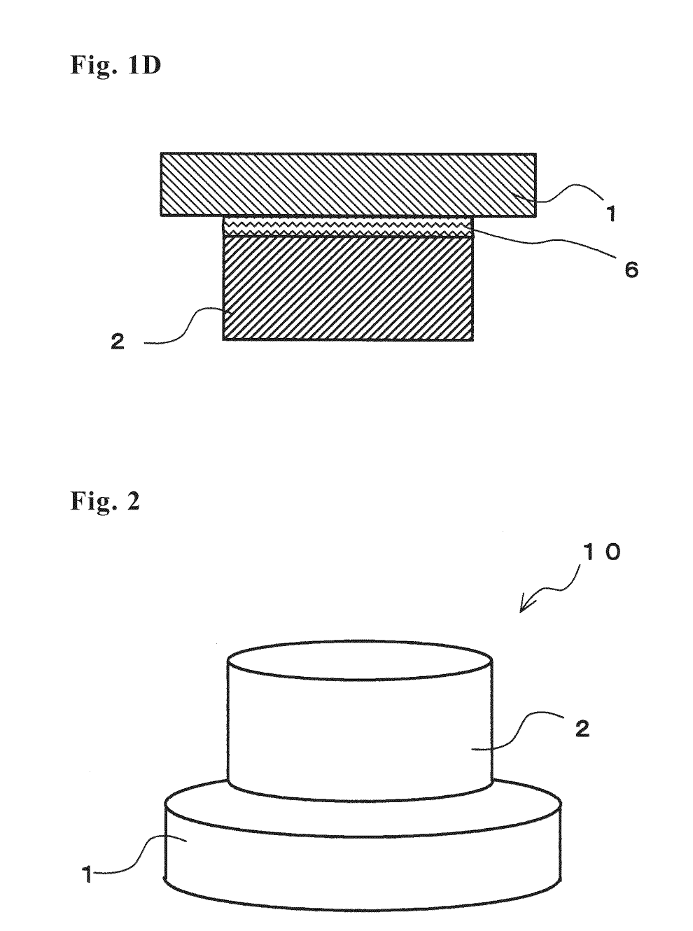

FIGS. 1A to 1D are schematic cross-sectional views illustrating a process for manufacturing a clad electrode of the present embodiment.

### EXAMPLE 1

First, as illustrated in FIG. 1A, a 0.3 mm-thick columnar precious metal tip 2 with 1.0 mm in diameter and made of a Pt—Rh (20%) alloy was placed in abutting contact with a 0.3 mm-thick tape-like base material 1 made of a Ni—Ir (1%) alloy, so as to be perpendicular to the base material. When this precious metal tip 2 was placed in abutting contact with a surface of the tape-like base material 1, care was taken to ensure that the precious metal tip was perpendicular to the base material, no gaps were present between an abutting surface of the precious metal tip and the surface of the base material, and a state of one-sided contact was not present therebetween.

Then, as illustrated in FIG. 1 B, electrodes (3 and 3′) for resistance welding were connected to the base material 1 and the precious metal tip 2, respectively, and resistance welding was performed under the conditions of a welding force of 7 kgf, a welding current of 1350 A and an electrical conduction time of 9 msec to preliminarily join the precious metal tip to the base material. In the present embodiment, these resistance welding conditions were varied to manufacture two types of preliminarily-joined clad materials.

After the preliminary joining process, a punching process was performed on the preliminarily-joined part with a blanking punch 4 having a predetermined diameter and a blanking die 5 associated with the blanking punch, as illustrated in FIG. 1C. Thereafter, a heat treatment was performed on the base material 1 and the precious metal tip 2 within an electrical furnace in vacuum under the conditions of a heating temperature of 1100° C. and a heating time of one hour. Cross-sectional observation confirmed that, as illustrated in FIG. 1D, a 30 μm-thick diffusion layer 6 was formed and the base material and the precious metal tip were diffusion-joined with this heat treatment. FIG. 2 illustrates a perspective view of a completed product form.

Subsequently, a description will be made of the results of evaluation tests conducted on clad electrodes manufactured in the present embodiment. For comparison, an evaluation was also made on an electrode for a spark plug manufactured with conventional laser welding. In this conventional laser welding method, the base end face of a columnar precious metal tip equal or similar in shape to the precious metal tips of the above-described embodiments was placed on a surface of the base material and a laser beam was intermittently radiated onto the outer circumference of the contact surface between the substrate and the precious metal tip, while the precious metal tip was supported with a predetermined support tool and the precious metal tip was rotated with the central axis line of the precious metal tip as a rotational axis. The output power of the laser beam at this time was 3 to 5 J.

In order to evaluate the clad electrode thus obtained, a delamination test of a joining face was conducted with an autograph (compression test). As a result, the strength of the electrode for a spark plug formed with conventional laser welding was less than a targeted strength of 300 N. In addition, a uniform shear plane was not obtained as the broken-out section of the electrode. In contrast, each clad electrode of the present embodiment had a strength of no less than 300 N and the broken-out section of the clad electrode was basically a shear plane. Consequently, the delamination test proved that the clad electrode had no gaps in the joining face thereof and was, therefore, a stable product.

In order to evaluate the clad electrode thus obtained, a test of thermal expansion/contraction between normal temperature and 1000° C. was also conducted to examine a state of delamination. As a result, the phenomenon of the precious metal tip (Pt alloy) and the base material (Ni alloy) separating from a joining end occurred frequently in the clad electrode formed with conventional laser welding. In contrast, this thermal expansion/contraction test also proved that no delamination was present in both of the external view and the cross section of the clad electrode of the present embodiment, and therefore, the clad electrode was extremely stable. These test results confirmed that the clad electrodes of the present embodiments had no problems in terms of practical use in an actual use environment.

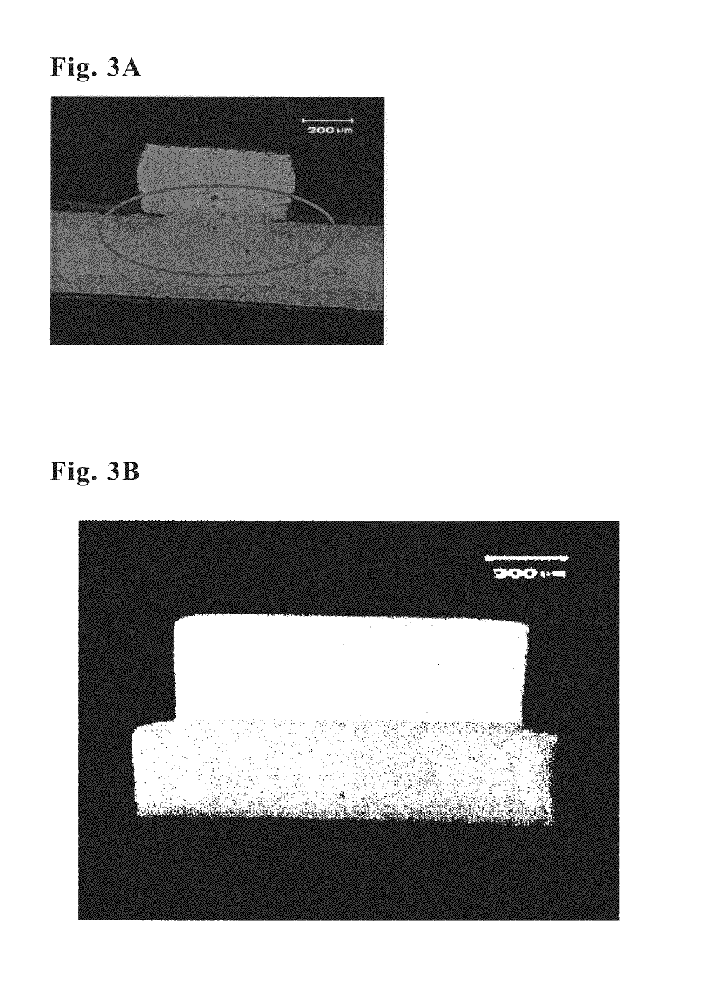

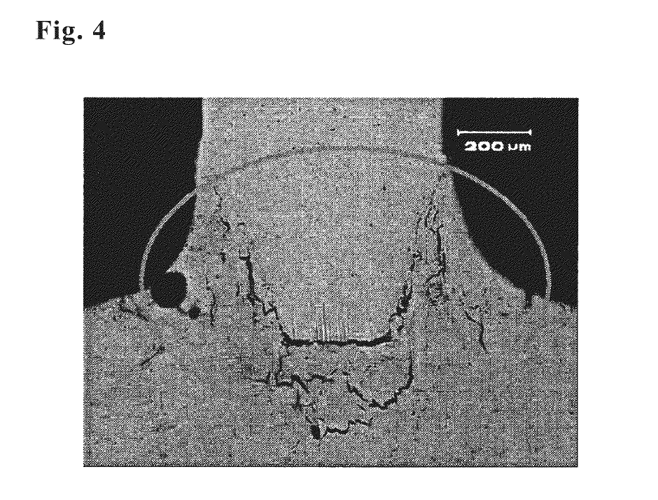

FIGS. 3A, 3B and 4 show cross-sectional observation photographs of a clad electrode after a thermal expansion/contraction test and a clad electrode formed with laser welding. FIGS. 3A and 3B are a cross-sectional observation photograph (FIG. 3A) of an electrode for a spark plug including an unjoined part in the outer peripheral surface of a joined part, and a cross-sectional observation photograph (FIG. 3B) of an electrode for a spark plug not including an unjoined part. The average length of the unjoined part in the electrode for a spark plug including the unjoined part was 40 μm on one side. From FIGS. 3A and 3B, it was observed that in the cross section of each of the two clad electrodes of the present embodiments, the thickness of a diffusion layer in a junction interface was almost uniform, and the junction interface was substantially planar. In addition, the observation photographs proved that the precious metal tip (upper side of each cross-sectional observation photograph) and the base material (lower side of each cross-sectional observation photograph) were joined with no cracks and voids included therein.

On the other hand, cracks were present in the joined part of the electrode for a spark plug formed with conventional laser welding, as illustrated in FIG. 4. The observation photograph shown in FIG. 4 thus confirmed that the precious metal tip had the possibility of separating from the joined part. In addition, a molten zone having a melt-solidification structure was formed, beginning from the outer peripheral surface of the joined part, to a thickness of 300 to 500 μm. This molten zone is not expected to serve as part of the precious metal tip. Accordingly, in order to make the electrode serve as designed, the precious metal tip needs to be made longer by as much as this thickness.

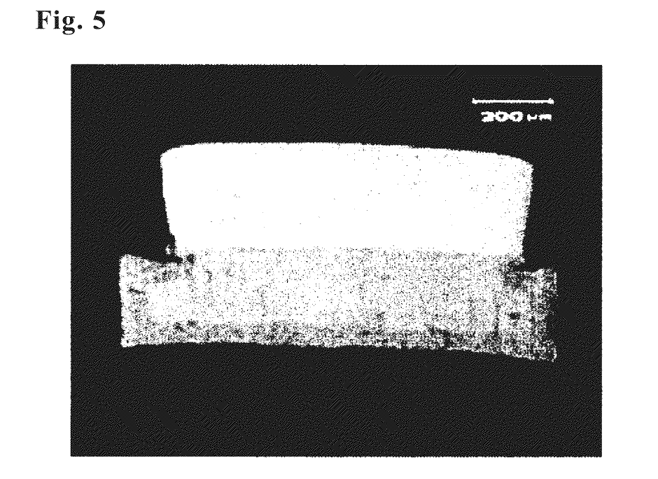

The clad electrode according to the present embodiment was subjected to a heat cycle test (200 heating/cooling cycles were performed between 70° C. and 1000° C. in the atmosphere), and then cross-sectional observation was conducted. Separation due to thermal expansion and contraction did not occur in a junction interface. FIG. 5 is a cross-sectional observation photograph of the electrode for a spark plug not including an unjoined part after heat cycling.

### EXAMPLE 2

As Example 2, a clad electrode was fabricated as described below. First, the same materials as those in Example 1 were prepared. Next, preliminary joining conditions were set to a welding force of 7 kgf the same as in Example 1, a welding current of 1110 A lower in output power than the resistance welding condition in Example 1, and an electrical conduction time of 100 msec. Then, the clad electrode was subjected to a diffusion joining process under the same heat treatment condition (1100° C.×1 hr) as in Example 1. The clad electrode of this Example 2 had the same properties as those of the clad electrode in Example 1.

### EXAMPLE 3

As Example 3, a clad electrode was fabricated from the same combination of materials as that of Example 2, under the same preliminary joining conditions as in Example 2, in a diffusion joining process under the heat treatment condition of 1200° C.×1 hr with the heat treatment condition varied toward the high temperature side. Cross-sectional observation of the clad electrode of this Example 3 showed that the diffusion layer of the clad electrode was 50 μm in thickness.

### EXAMPLE 4

As Example 4, a clad electrode was fabricated from the combination of materials shown in Example 2, under the same preliminary joining conditions as in Example 2, in a diffusion joining process under the heat treatment condition of 1100° C.×2 hrs. Cross-sectional observation of the clad electrode of this Example 4 showed that the diffusion layer of the clad electrode was 40 μm in thickness.

### EXAMPLE 5

As Example 5, a clad electrode was fabricated as described below. First, the same materials as those in Example 1 were prepared. Next, preliminary joining conditions were set to a welding force of 7 kgf the same as in Example 1, a welding current of 1400 A higher in output power than the resistance welding condition in Example 1, and an electrical conduction time of 4 msec. Then, the clad electrode was subjected to a diffusion joining process under the heat treatment condition of 1200° C.×4 hrs. Cross-sectional observation of the clad electrode of this Example 5 showed that the diffusion layer of the clad electrode was 90 μm thickness.

### EXAMPLE 6

As Example 6, a clad electrode was fabricated as described below. First, there were prepared a 0.3 mm-thick tape-like base material 1 made of a Cu—Ni (30%) alloy different from that of Example 1 and a 0.3 mm-thick columnar precious metal tip with 1.0 mm in diameter and made of an Pt—Ir (20%) alloy. Next, preliminary joining conditions were set to a welding force of 7 kgf the same as in Example 1, a welding current of 600 A lower in output power than the resistance welding condition in Example 1, and an electrical conduction time of 200 msec. Then, the clad electrode was subjected to a diffusion joining process under the heat treatment condition of 900° C.×3 hrs. Cross-sectional observation of the clad electrode of this Example 6 showed that the diffusion layer of the clad electrode was 10 μm in thickness.

The same delamination test and thermal expansion/contraction test as those in Example 1 conducted on the above-described clad electrodes of Examples 2 to 6 proved that the clad electrodes were extremely superior in all properties. These results have clarified that even if manufacturing conditions vary more or less in a production line, the properties of each clad electrode can be maintained at a practical level as long as the manufacturing conditions are within a correct range, and that quality control conditions are also easy to control.

### INDUSTRIAL APPLICABILITY

According to the present invention, it is possible to securely maintain junction between the precious metal tip and the base material and extend the service life of a spark plug. Consequently, it is possible to efficiently use precious metal and save natural resources.

### REFERENCE SIGNS LIST

1: Base material

2: Precious metal tip

3: Electrode for resistance welding

6: Diffusion layer

10: Clad electrode

1. A clad electrode for a spark plug comprising a precious metal tip arranged at a leading end of a spark plug and a base material to which the precious metal tip is joined, wherein a junction interface between the precious metal tip and the base material is substantially planar.

2. The clad electrode for a spark plug according to claim 1, wherein a 5 μm to 100 μm-thick diffusion layer is formed in a joined part between the precious metal tip and the base material.

3. The clad electrode for a spark plug according to claim 2, the clad electrode including an unjoined part on the outer peripheral surface of the joined part between the precious metal tip and the base material, wherein the length of the unjoined part is no greater than one-fifth the radius of the precious metal tip.

4. The clad electrode for a spark plug according to claim 1, wherein the precious metal tip is made of a Pt alloy or an Ir alloy.

5. The clad electrode for a spark plug according to claim 1, wherein the base material is a Ni alloy or a Cu alloy.

6. The clad electrode material for a spark plug defined in claim 1, wherein a joining face of a substantially columnar precious metal tip is in abutting contact with a surface of a base material, the precious metal tip is joined to the surface of the base material with resistance welding, and the base material and the precious metal tip are diffusion-joined with heat treatment, thereby integrating the base material and the precious metal tip with each other.

7. A method for manufacturing a clad electrode for a spark plug defined in claim 1, the method comprising the steps of:
placing a joining face of a substantially columnar precious metal tip in abutting contact with a surface of a base material;
preliminarily joining the precious metal tip to a surface of the base material with resistance welding;
punching out a part in which the base material and the precious metal tip are integrated with each other; and
diffusion-joining the base material and the precious metal tip with heat treatment, thereby forming the clad electrode.

8. The method for manufacturing a clad electrode for a spark plug according to claim 7, wherein resistance welding conditions in preliminary joining are a welding force of 5 to 10 kgf, a welding current of 500 to 1500A, and an electrical conduction time of 2 to 200 msec, and heat treatment conditions in diffusion joining are a heating temperature of 800 to 1200° C. and a processing time of 1 to 5 hours in vacuum, in a reduction atmosphere, or in an inert atmosphere.

9. The clad electrode for a spark plug according to claim 2, wherein the precious metal tip is made of a Pt alloy or an Ir alloy.

10. The clad electrode for a spark plug according to claim 3, wherein the precious metal tip is made of a Pt alloy or an Ir alloy.

11. The clad electrode for a spark plug according to claim 2, wherein the base material is a Ni alloy or a Cu alloy.

12. The clad electrode for a spark plug according to claim 3, wherein the base material is a Ni alloy or a Cu alloy.

13. The clad electrode for a spark plug according to claim 4, wherein the base material is a Ni alloy or a Cu alloy.

14. The clad electrode for a spark plug according to claim 9, wherein the base material is a Ni alloy or a Cu alloy.

15. The clad electrode for a spark plug according to claim 10, wherein the base material is a Ni alloy or a Cu alloy.

16. The clad electrode material for a spark plug defined in claim 2, wherein a joining face of a substantially columnar precious metal tip is in abutting contact with a surface of a base material, the precious metal tip is joined to the surface of the base material with resistance welding, and the base material and the precious metal tip are diffusion-joined with heat treatment, thereby integrating the base material and the precious metal tip with each other.

17. The clad electrode material for a spark plug defined in claim 3, wherein a joining face of a substantially columnar precious metal tip is in abutting contact with a surface of a base material, the precious metal tip is joined to the surface of the base material with resistance welding, and the base material and the precious metal tip are diffusion joined with heat treatment, thereby integrating the base material and the precious metal tip with each other.

18. The clad electrode material for a spark plug defined in claim 4, wherein a joining face of a substantially columnar precious metal tip is in abutting contact with a surface of a base material, the precious metal tip is joined to the surface of the base material with resistance welding, and the base material and the precious metal tip are diffusion-joined with heat treatment, thereby integrating the base material and the precious metal tip with each other.

19. The clad electrode material for a spark plug defined in claim 5, wherein a joining face of a substantially columnar precious metal tip is in abutting contact with a surface of a base material, the precious metal tip is joined to the surface of the base material with resistance welding, and the base material and the precious metal tip are diffusion-joined with heat treatment, thereby integrating the base material and the precious metal tip with each other.

20. The clad electrode material for a spark plug defined in claim 9, wherein a joining face of a substantially columnar precious metal tip is in abutting contact with a surface of a base material, the precious metal tip is joined to the surface of the base material with resistance welding, and the base material and the precious metal tip are diffusion-joined with heat treatment, thereby integrating the base material and the precious metal tip with each other.
